(19) United States
(12) Patent Application Publication
(10) Pub. No.: US 2023/0059901 A1
(43) Pub. Date: Feb. 23, 2023

(54) SADDLE-RIDE VEHICLE

(71) Applicant: HONDA MOTOR CO., LTD., Tokyo (JP)

(72) Inventors: Shohei Kamochi, Tokyo (JP); Hiromitsu Shiina, Tokyo (JP); Yosuke Kajiwara, Tokyo (JP)

(21) Appl. No.: 17/864,772

(22) Filed: Jul. 14, 2022

(30) Foreign Application Priority Data
Aug. 18, 2021 (JP) 2021-133174

(51) Int. Cl. B62K 11/00; B62J 45/00; B62J 41/00; B01D 53/04

(52) U.S. Cl. CPC B62K 11/00; B62J 45/00; B62J 41/00; B01D 53/0415; B62K 2204/00; B01D 2259/4516

(57) ABSTRACT

In a saddle-ride vehicle including an engine, and a component disposed near the engine, a member is disposed between the engine and the component, and the member is a resistor that is one of the components of the saddle-ride vehicle.

### INCORPORATION BY REFERENCE

The present application claims priority under 35 U.S.C.§ 119 to Japanese Patent Application No. 2021-133174 filed on Aug. 18, 2021. The content of the application is incorporated herein by reference in its entirety.

### BACKGROUND

### Technical Field

The present invention relates to a saddle-ride vehicle.

### Related Art

In one disclosed configuration of a saddle-ride vehicle, a canister is provided in front of an engine, and an expansion portion that expands out from a housing box is provided between the canister and the engine (for example, JP 2010-155506 A). According to this configuration, thermal effects from the engine to the canister can be reduced.

### SUMMARY

However, the prior-art configuration is limited to vehicles with a housing box in front of the engine and requires modification of the shape of the housing box and others.

In general, since the layout of components in a saddle-ride vehicle is determined by taking various conditions into consideration, some vehicles may place components near the engine that should receive less thermal effects. In this case, it is desirable to reduce the thermal effects of the engine on the components with a simple configuration.

The present invention has been made in view of the above circumstances, and an object of the present invention is to reduce the thermal effects of the engine on the components disposed near the engine using a simple configuration.

A saddle-ride vehicle includes an engine, and a component disposed near the engine, in which a member is disposed between the engine and the component, and the member is a resistor that is one of the components of the saddle-ride vehicle.

The thermal effects of the engine on the component disposed near the engine can be reduced with a simple configuration.

### BRIEF DESCRIPTION OF DRAWINGS

FIG. 1 is a side view illustrating a saddle-ride vehicle according to an embodiment of the present invention;

FIG. 2 is a view of a saddle-ride vehicle seen from above;

FIG. 3 is a schematic view of a canister seen from above the vehicle body along with the surrounding configuration;

FIG. 4 is a schematic view of a resistor;

FIG. 5 is a perspective view schematically illustrating a resistor according to a modification; and

FIG. 6 is a view schematically illustrating a relationship between the traveling wind from the front of the vehicle body and the canister from above the vehicle body.

### DETAILED DESCRIPTION

Embodiments of the present invention will be described below with reference to the drawings. In the description, directions such as front, rear, left, right, up, and down are the same as the directions with respect to a vehicle body unless otherwise specified. In each of the drawings, the reference sign FR denotes the front direction of the vehicle body, the reference sign UP denotes the upward direction of the vehicle body, and the reference sign LH denotes the left direction of the vehicle body.

### Embodiment

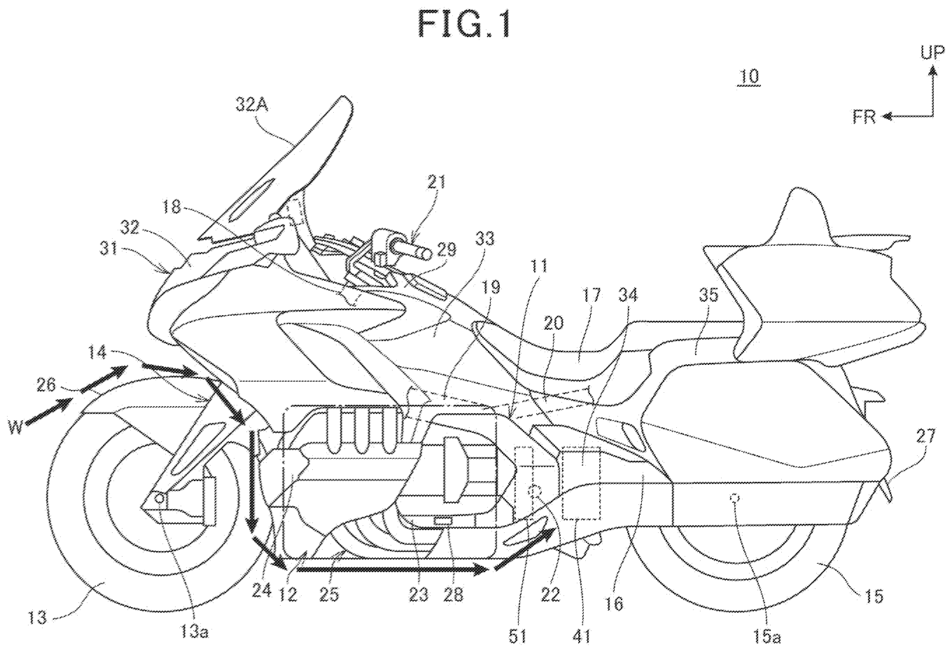

FIG. 1 is a side view of a saddle-ride vehicle according to an embodiment of the present invention.

The saddle-ride vehicle 10 is a vehicle including a vehicle body frame 11, a power unit 12 supported by the vehicle body frame 11, a front fork 14 that supports a front wheel 13 in a steerable manner, a swing arm 16 that supports a rear wheel 15, and a seat 17 for a rider.

The saddle-ride vehicle 10 is a vehicle on which the rider sits astride the seat 17. The seat 17 is provided above a rear portion of the vehicle body frame 11.

The vehicle body frame 11 includes a head pipe 18 provided at a front end portion of the vehicle body frame 11, a front frame 19 located behind the head pipe 18, and a rear frame 20 located behind the front frame 19. A front end portion of the front frame 19 is connected to the head pipe 18.

The seat 17 is supported by the rear frame 20.

The front fork 14 is supported by the head pipe 18 in a left-and-right steerable manner. The front wheel 13 is supported by an axle 13a provided at a lower end portion of the front fork 14. A steering handlebar 21 gripped by the rider is attached to an upper end portion of the front fork 14.

The swing arm 16 is supported by a pivot shaft 22, which is further supported by the vehicle body frame 11. The pivot shaft 22 is a shaft extending horizontally in a vehicle width direction. The pivot shaft 22 is inserted in a front end portion of the swing arm 16. The swing arm 16 vertically swings about the pivot shaft 22.

The rear wheel 15 is supported by an axle 15a provided at a rear end portion of the swing arm 16.

The power unit 12 is disposed between the front wheel 13 and the rear wheel 15, and is supported by the vehicle body frame 11.

The power unit 12 is an internal combustion engine. The power unit 12 includes a crankcase 23, and a cylinder portion 24 that houses a reciprocating piston. The cylinder portion 24 has an exhaust port, to which an exhaust device 25 is connected.

Output of the power unit 12 is transmitted to the rear wheel 15 by a driving-force transmission member connecting the power unit 12 and the rear wheel 15.

In addition, the saddle-ride vehicle 10 also includes a front fender 26 that covers the front wheel 13 from above, a rear fender 27 that covers the rear wheel 15 from above, a step 28 on which the rider places a foot, and a fuel tank 29 that stores fuel used by the power unit 12.

The front fender 26 is attached to the front fork 14. The rear fender 27 and the step 28 are provided below the seat 17. The fuel tank 29 is supported by the vehicle body frame 11.

The saddle-ride vehicle 10 includes a vehicle body cover 31 that covers various portions of the vehicle body. The vehicle body cover 31 includes a front cover (also referred to as a front cowl) 32 that covers the front of the saddle-ride vehicle 10 from the front and from the left and right, and a middle cover (also referred to as a middle cowl) 33 that covers the area between the steering handlebar 21 and the seat 17 from the left and right. In addition, the vehicle body cover 31 includes a lower side cover 34 that covers the lower portion of the seat 17 from the left and right, and a rear cover 35 that covers the rear portion of the saddle-ride vehicle 10 from the left and right. A windscreen 32A extending rearward and upward is attached to the front cover 32.

The power unit 12 is a horizontally opposed engine and includes a crankcase 23 located in the center of the vehicle width and a cylinder portion 24 provided on the left and right sides of the crankcase 23. Therefore, the power unit 12 is an engine having a larger width than an engine including a cylinder portion that stands at the front of the crankcase 23 or the like (which may be referred to as a vertical engine). The rear portion of the crankcase 23 houses a transmission mechanism, a clutch mechanism, and others.

In the present invention, the power unit 12 is not limited to a horizontally opposed engine and may be any engine.

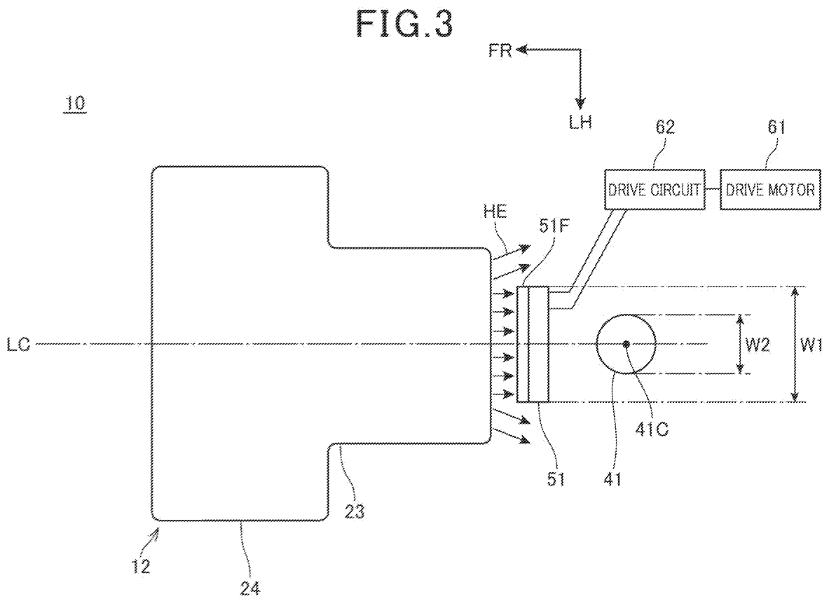

The saddle-ride vehicle 10 includes a drive motor 61 (FIG. 3) as the other power unit for driving the drive wheels (the rear wheels 15 in the present embodiment). By including the drive motor 61, the saddle-ride vehicle 10 includes, for example, a slow forward/backward traveling function to travel forward or backward at a slow speed.

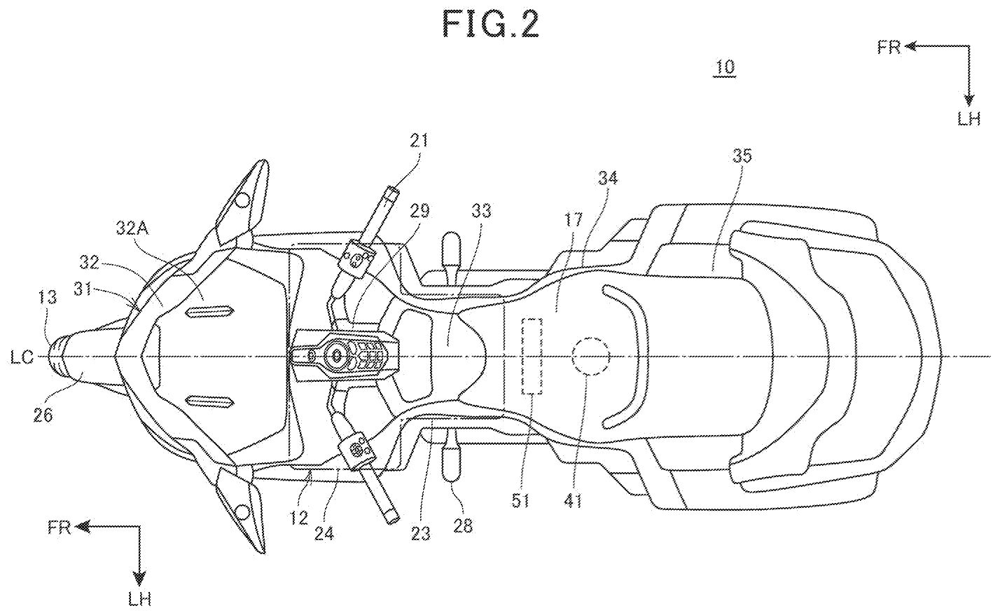

FIG. 2 is a view of a saddle-ride vehicle 10 seen from above. In FIG. 2, the reference sign LC is a line indicating the center of the width of the saddle-ride vehicle 10 (also referred to as a width center). In FIGS. 1 and 2, the outline of the power unit 12 is schematically illustrated in single dotted lines.

As illustrated in FIGS. 1 and 2, a canister 41 is disposed behind and near the power unit 12 to suppress the emission of evaporated fuel from the saddle-ride vehicle 10.

The canister 41 is formed in a cylindrical shape with closed ends and is a device that adsorbs the evaporated fuel generated in the fuel tank 29. A charge hose leading to the fuel tank 29, a purge hose leading to the intake passage, an open hose leading to the atmosphere, and a drain hose are connected to the canister 41. Since the 41 canister suppresses the emission of evaporated fuel to the outside of the vehicle, it functions as one of the environmental countermeasure components that contribute to environmental improvement and the realization of the Sustainable Development Goals (SDGs). Known canister structures may be widely applied to the canister 41.

As illustrated in FIGS. 1 and 2, the canister 41 is disposed behind the power unit 12 and within the width (corresponding to the length in the left-right direction) of the power unit 12. Located behind the power unit 12 are the lower side cover 34 that covers the lower portion of the seat 17 from the left and right, a part of the rear frame 20, the swing arm 16, a power transmission member between the power unit 12 and the rear wheel 15, and others. The canister 41 is disposed in the space available between the lower side cover 34, a part of the rear frame 20, the swing arm 16, the power transmission member, and others, the space being available in front of the rear wheel 15.

FIG. 3 is a schematic view of the canister 41 seen from above the vehicle body along with the surrounding configuration. The canister 41 is disposed in a posture in which the lateral length (corresponding to width) is shorter than the vertical length by placing a cylindrical central axis 41C along the vertical direction. This posture facilitates disposing the canister 41 in the free space located behind the power unit 12 and in front of the rear wheels 15.

The position and posture of the canister 41 may be changed according to the available space, for example, the canister 41 may be tilted in at least one of the front-rear direction and the left-right direction. The shape of the canister 41 need not be limited to a cylindrical shape, and may have a shape other than cylindrical.

The engine, which is the power unit 12, is the heat source that releases heat. When the canister 41 is disposed around the power unit 12, heat from the power unit 12 may cause the temperature of the canister 41 to rise.

As the temperature of the canister 41 rises, a minute amount of fuel in the canister 41 may volatilize and diffuse to the outside. Therefore, in order to prevent fuel diffusion from the saddle-ride vehicle 10 to the surroundings, it is desirable to reduce the thermal effects of heat sources such as the power unit 12 on the canister 41. In particular, in a vehicle where the canister 41 must be disposed near the power unit 12, it is desirable to reduce the thermal effects of the power unit 12 on the canister 41.

In the present embodiment, as illustrated in FIG. 3, the thermal effects on the canister 41 are reduced by disposing the resistor 51, which is one of the components of the saddle-ride vehicle 10, between the power unit 12 and the canister 41.

The resistor 51 is a resistor for the drive motor 61 and is a heat-resistant component among the electrical components included in the saddle-ride vehicle 10.

As illustrated in FIG. 3, the saddle-ride vehicle 10 includes a drive circuit 62 that drives the drive motor 61 in response to the operation of the driver as the rider, and the resistor 51 is electrically connected to the drive circuit 62 via wiring. The resistor 51 is used to convert a part of the drive current of the drive motor 61 into heat when the drive motor 61 drives the saddle-ride vehicle 10 backward.

The resistor of this type is used to convert a part of the current into heat to prevent a large current flow when the rotation of the drive motor 61 fluctuates. Especially during backward traveling, the gas pedal opening (also called throttle opening) is not fully opened, and the motor current needs to be reduced, so a resistor is required. The timing of when the resistor 51 is used during backward traveling or when any condition is met may be designed as appropriate.

This resistor 51 may be a larger component than the chip resistor that is mounted on the printed circuit board to regulate the electronic circuit, may be referred to as a power resistor, in which case it is referred to as a power resistor.

By disposing the resistor 51, which is a heat resistant and relatively large component, between the power unit 12 and the canister 41, as illustrated in FIG. 3, heat (denoted by reference sign HE) released from the power unit 12 toward the canister 41 can be blocked by the resistor 51.

This resistor 51 and its arrangement are further described below.

As illustrated in FIG. 3, the resistor 51 has a thin rectangular shape and is disposed with one of its large opposing sides facing toward the power unit 12 and along the vehicle width direction.

The left-right center of the resistor 51 coincides with the width center LC of the saddle-ride vehicle 10. The lateral length (corresponding to the width) W1 of the resistor 51 is larger than the lateral length (corresponding to the width) W2 of the canister 41. As illustrated in FIG. 1, the vertical length of the resistor 51 is substantially equal to the vertical length of the canister 41.

As illustrated in FIGS. 1 to 3, the resistor 51 is spaced from the power unit 12, and is also spaced from the canister 41. Furthermore, the resistor 51 is disposed in a position that overlaps with the power unit 12 in the front-rear direction.

This arrangement of the resistor 51 facilitates effective suppression of the thermal effects of the power unit 12 on the resistor 51. A known attachment structure may be widely adopted as the attachment structure of the resistor 51.

In addition, of the surfaces of the resistor 51, heat dissipating fins 51F are provided on the side of the power unit 12. For example, the resistor 51 is covered by a metal case, and a part of the metal case is formed into the heat dissipating fins 51F.

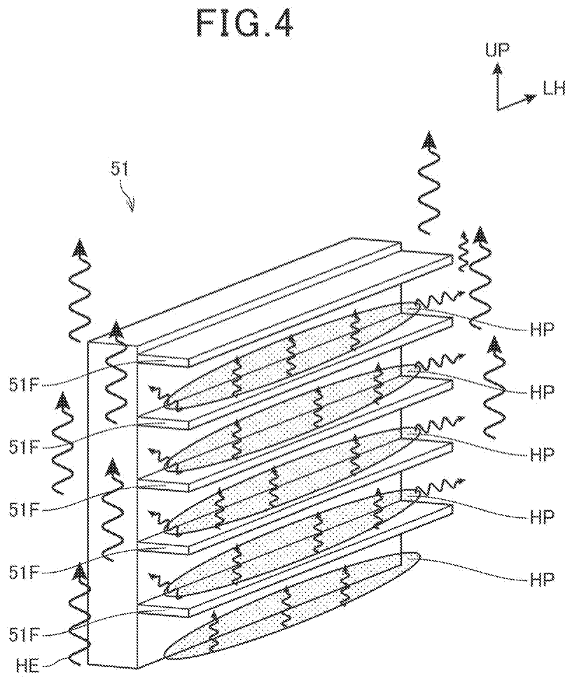

FIG. 4 is a schematic view of the resistor 51. For convenience of description, in FIG. 4, examples of regions of radiant heat from the power unit 12 are indicated by reference sign HR, respectively, and the transfer of heat from each region HR is indicated by arrows.

As illustrated in FIG. 4, the heat dissipating fins 51F are formed into horizontal fins extending along the vehicle width direction, and are spaced apart in the vertical direction of the vehicle body. These heat dissipating fins 51F increase the heat dissipation area of the resistor 51 compared to the case without the heat dissipating fins 51F. This allows the radiant heat transferred from the power unit 12 to each region HR to be efficiently dissipated by the heat dissipating fins 51F, and facilitates control of temperature rise due to heat generated by the resistor 51 itself.

In addition, since this resistor 51 is not used during forward traveling, it does not generate heat during forward traveling. Therefore, the temperature rise of the canister 41 due to the heat generated by the resistor 51 itself during forward traveling can be avoided. In addition, the heat transferred from the power unit 12 to the resistor 51 during forward traveling can be efficiently dissipated by the heat dissipating fins 51F.

By providing the heat dissipating fins 51F, the gap between the resistor 51 and the power unit 12 is narrower than when the heat dissipating fins 51F are not provided. This increases the velocity of the fluid flowing between the resistor 51 and the power unit 12 from the surroundings (a fluid that transfers heat, for example, outside air (including traveling wind)), according to Bernoulli's theorem. Thus, heat from the power unit 12 can be quickly discharged out of the resistor 51.

Furthermore, since the heat dissipating fins 51F are provided on the side of the power unit 12 in the resistor 51, the side of the power unit 12 in the resistor 51 is smaller than the cross-sectional area around the power unit 12 due to the heat dissipating fins 51F. According to Bernoulli's theorem, if the volume of fluid flowing per unit time is constant, the smaller the cross-sectional area, the greater the velocity of the fluid.

In this configuration, heat from the power unit 12 enters the narrow space between the fins of the resistor 51 (corresponding to a relatively small cross-sectional area) from the open space between the resistor 51 and the power unit 12 (corresponding to a relatively large cross-sectional area). Thus, heat from the power unit 12 is more easily discharged out of the resistor 51.

The heat dissipating fin 51F is not limited to horizontal fins, and may also be vertical fins extending in the vertical direction of the vehicle body. In addition, the direction of extension, spacing, and thickness of the heat dissipating fins 51F may be set as desired.

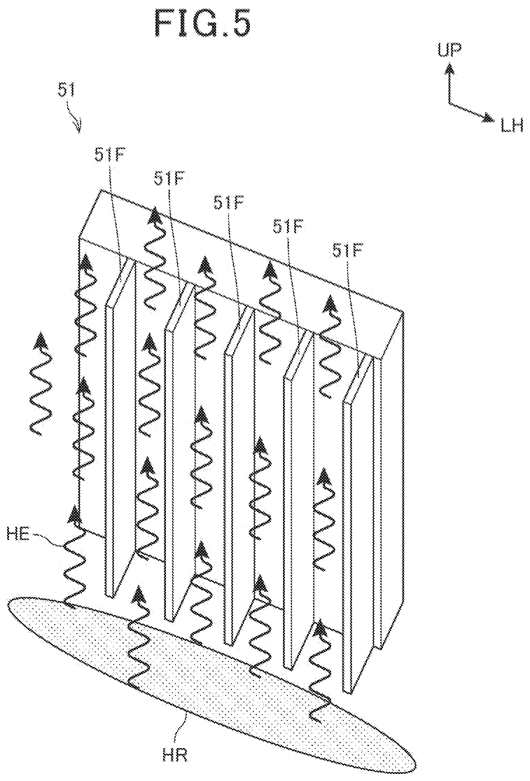

FIG. 5 is a perspective view schematically illustrating the resistor 51 according to a modification. For convenience of description, FIG. 5 illustrates an example of the region HR of radiant heat from the power unit 12 below the resistor 51, and arrows indicate the transfer of heat from that region HR.

As illustrated in FIG. 5, the heat dissipating fins 51F extend along the vertical direction of the vehicle body to guide the heat rise from the region HR of radiant heat and to keep the heat rise unhindered. This facilitates the suppression of the occurrence of heat retention (so-called heat buildup) between the power unit 12 and the resistor 51. This dissipates radiant heat from the power unit 12 more efficiently and facilitates the suppression of temperature rise due to heat generation by the resistor 51 itself.

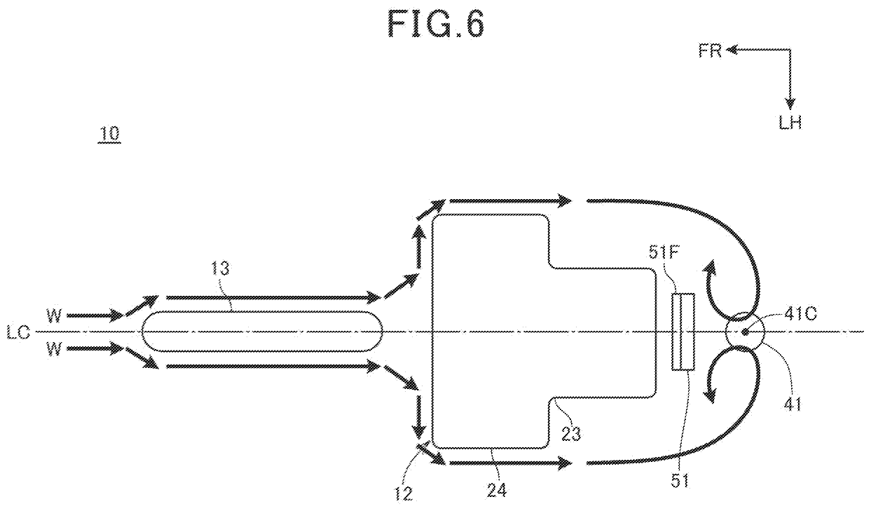

FIG. 6 is a view schematically illustrating a relationship between the traveling wind W from the front of the vehicle body and the canister 41 from above the vehicle body. As illustrated in FIG. 6, the power unit 12 larger than the front wheel 13 in the left-right direction is located behind the front wheel 13. Therefore, when the saddle-ride vehicle 10 is traveling forward, it is expected that the traveling wind W from the front of the vehicle body will change direction significantly to the left and right outward in front of the power unit 12 (between the front wheel 13 and the power unit 12), which is an obstacle, and after flowing on both sides of the power unit 12, the left and right traveling winds W will merge behind the power unit 12. It is also expected that a swirling flow will occur in the vicinity of the confluence point of the left and right traveling winds W.

In the present embodiment, the resistor 51 and the canister 41 are disposed behind the power unit 12 and within the width of the power unit 12. The space where the resistor 51 and the canister 41 are disposed is the space where the traveling wind W from the front flows to the left and right of the power unit 12 and merges behind the power unit 12. This facilitates effective air cooling of the resistor 51 and the canister 41 by the outside air including the traveling wind W from the front.

FIG. 6 illustrates an example of a case in which the canister 41 is located near the confluence point of the traveling wind W. According to this configuration, the canister 41 can be effectively air-cooled by the outside air including the traveling wind W.

FIG. 1 illustrates the flow of a part of the traveling wind W from the front of the vehicle when viewed from the side of the vehicle.

As illustrated in FIG. 1, a part of the traveling wind W around the front fender 26 turns downward in front of the power unit 12, which is an obstacle, and passes under the power unit 12. The region behind the power unit 12 has a negative pressure compared to the region below the power unit 12. Therefore, a part of the traveling wind W that passes below the power unit 12 flows into the region of negative pressure behind the power unit 12. Therefore, the traveling wind W in FIG. 1 also facilitates effective air cooling of the resistor 51, the canister 41, and others disposed behind the power unit 12. In this case, the canister 41 can also function as a traveling wind guard that reduces the amount of traveling wind W from the front of the vehicle body hitting the front of the rear wheel 15.

As described above, the saddle-ride vehicle 10 of the present embodiment includes the resistor 51, which is one of the components of the saddle-ride vehicle 10, between the power unit 12 and the canister 41.

The resistor 51 is generally heat resistant and can withstand the heat generated by the power unit 12, so it can be disposed near the power unit 12. In the present embodiment, the resistor 51 used in the saddle-ride vehicle 10 is disposed between the power unit 12 and the canister 41, so there is no need to provide another component or change the shape of existing components to reduce the thermal effects of the power unit 12. Therefore, the thermal effects of the power unit 12 on the canister 41 disposed near the power unit 12 can be reduced with a simple configuration.

In addition, the resistor 51 is an electrical component that is used only in predetermined traveling conditions. Since the resistor 51, which is used only in predetermined traveling conditions, generates heat infrequently, facilitating the suppression of the thermal effects of the resistor 51 on the canister 41.

Moreover, the resistor 51 is a resistor for the drive motor 61 installed in the saddle-ride vehicle 10. When the drive motor 61 is not in use, the resistor 51 does not generate heat, facilitating the suppression of the thermal effects of the resistor 51 itself on the canister 41. Even when the drive motor 61 is in use, the resistor 51 is not used during other than predetermined traveling conditions, the resistor 51 generates heat less frequently even when the drive motor 61 is in use, facilitating the suppression of the thermal effects of the resistor 51 itself on the canister 41.

The drive motor 61 is a motor that can drive the rear wheel 15, which is the drive wheel of the saddle-ride vehicle 10, and the resistor 51 is used during backward traveling of the saddle-ride vehicle 10 by the drive motor 61. Normally, in traveling of the saddle-ride vehicle 10, the frequency of backward traveling is considered to be less than the frequency of forward traveling. Since the resistor 51 is used during backward traveling of the saddle-ride vehicle 10, the resistor 51 does not generate heat during forward traveling of the saddle-ride vehicle 10, and the resistor 51 generates heat infrequently. This facilitates the suppression of the thermal effects of the resistor 51 itself on the canister 41.

In addition, since the resistor 51 includes the heat dissipating fins 51F, the heat of the resistor 51 itself can be efficiently dissipated by the heat dissipating fins 51F, and the heat transferred from the power unit 12 to the resistor 51 can also be easily dissipated efficiently.

Furthermore, the heat dissipating fins 51F are provided on the side of the power unit 12 in the resistor 51. According to this configuration, heat from the power unit 12 can be easily discharged out of the resistor 51 by allowing the heat from the power unit 12 to enter the narrow space between the fins of the resistor 51 from the open space between the resistor 51 and the power unit 12. These facilitate the suppression of the thermal effects of the power unit 12 on the canister 41.

Furthermore, since the heat dissipating fins 51F extend along the vertical direction of the vehicle body, the heat dissipating fins 51F can guide the heat rise from the power unit 12 and keep the heat rise unhindered. This facilitates the suppression of heat buildup between the power unit 12 and the resistor 51, and further facilitates the suppression of the thermal effects of the power unit 12 on the canister 41.

In addition, the resistor 51 and canister 41 are disposed behind the power unit 12 and within the width of the power unit 12. Therefore, disposing the resistor 51 and the canister 41 at or near the confluence point where the traveling wind W from the front flows to the left and right of the power unit 12 and merges behind the power unit 12 facilitates effective air cooling of the resistor 51 and the canister 41 by the outside air including the traveling wind.

When there is a free space in front of the power unit 12, the canister 41 may be disposed in front of the power unit 12 via the resistor 51. In this case, disposing the resistor 51 and the canister 41 at or near the confluence point where the traveling wind from the rear flows to the left and right of the power unit 12 and merges in front of the power unit 12 facilitates effective air cooling of the resistor 51 and the canister 41 by the outside air including the traveling wind.

The canister 41, used as an environmental countermeasure component amid the growing emphasis on environmental issues, may cause fuel diffusion to the outside, albeit in minute amounts, due to temperature rise. In the present embodiment, even when the canister 41 is disposed near the power unit 12, the thermal effects of the power unit 12 on the canister 41 can be reduced, thus suppressing the temperature rise of the canister 41 and the diffusion of fuel from the canister 41 itself to the outside. This can adequately prevent fuel diffusion from the saddle-ride vehicle 10 to the outside, which contributes to environmental improvement and is suitable for the realization of the Sustainable Development Goals (SDGs).

Note that the above embodiment merely indicates an aspect of the present invention, and the present invention is not limited to the above embodiment. For example, the case of reducing the thermal effects of the power unit 12 on the canister 41 is described above, but the object need not be limited to the canister 41. In the present invention, any component that should receive less thermal effects from the power unit 12 may be substituted for the canister 41.

The resistor 51 used to reduce the thermal effects of the power unit 12 need not be limited to a resistor for the drive motor 61, and need not be limited to a resistor used during backward traveling. An appropriate resistor may be selected from a plurality of resistors included in the components of the saddle-ride vehicle 10.

Although the case in which the present invention is applied to the saddle-ride vehicle 10 illustrated in FIG. 1 is described, the application of the invention is not limited to this case, and the invention may be applied to scooter-type motorcycles and saddle-ride vehicles, including three-wheel and four-wheel types as well.

[Configurations Supported by Above Embodiments]

The above embodiments support the following configurations.

(Configuration 1) A saddle-ride vehicle including: an engine; and a component disposed near the engine, in which a member is disposed between the engine and the component, and the member is a resistor that is one of the components of the saddle-ride vehicle.

Resistors are generally heat resistant and can withstand the heat generated by the engine, so they can be disposed near the engine. In the present configuration, the resistor used in the saddle-ride vehicle is included between the engine and the component, so there is no need to provide another component or change the shape of existing component to reduce the thermal effects of the engine. Therefore, the thermal effects of the engine on the component disposed near the engine can be reduced with a simple configuration.

(Configuration 2) The saddle-ride vehicle according to configuration 1, in which the resistor is a component that is used only in a predetermined traveling condition.

Since the resistor, which is used only in predetermined traveling conditions, generates heat infrequently, facilitating the suppression of the thermal effects of the resistor itself on the canister.

(Configuration 3) The saddle-ride vehicle according to configuration 2, in which the resistor is a resistor for a drive motor provided in the saddle-ride vehicle.

When the drive motor is not in use, the resistor does not generate heat, facilitating suppression of the thermal effects of the resistor itself on the canister. Even when the drive motor is in use, the resistor is not used during other than predetermined traveling conditions, the resistor generates heat infrequently even when the drive motor is in use, facilitating suppression of the thermal effects of the resistor itself on the canister.

(Configuration 4) The saddle-ride vehicle according to configuration 3, in which the drive motor is a motor capable of driving a drive wheel of the saddle-ride vehicle, and the resistor is used during backward traveling of the saddle-ride vehicle by the drive motor.

Since the resistor is used during backward traveling of the saddle-ride vehicle, the resistor does not generate heat during forward traveling of the saddle-ride vehicle, and the resistor generates heat infrequency. This facilitates the suppression of the thermal effects of the resistor itself on the component.

(Configuration 5) The saddle-ride vehicle according to any one of configurations 1 to 4, in which the resistor includes a heat dissipating fin.

Since the resistor includes the heat dissipating fin, the heat of the resistor itself can be efficiently dissipated by the heat dissipating fin, and the heat transferred from the engine to the resistor can also be easily dissipated efficiently. This further facilitates the suppression of the thermal effects of the resistor itself on the component.

(Configuration 6) The saddle-ride vehicle according to configuration 5, in which the heat dissipating fin is provided on an engine side face of the resistor.

Since the heat dissipating fin is provided on the engine side face in the resistor, heat from the engine can easily be discharged out of the resistor by allowing the heat from the engine to enter the narrow space between the fins of the resistor from the open space between the resistor and the engine. This further facilitates the suppression of the thermal effects of the engine on the component.

(Configuration 7) The saddle-ride vehicle according to configuration 6, in which the heat dissipating fin extends along a vertical direction of a vehicle body.

Since the heat dissipating fin extends along the vertical direction of the vehicle body, the heat dissipating fin can guide the heat rise from the engine and keep the heat rise unhindered, facilitating suppression of the heat retention between the engine and the resistor. This further facilitates the suppression of the thermal effects of the engine on the component.

(Configuration 8) The saddle-ride vehicle according to any one of configurations 1 to 7, in which the resistor and the component are disposed within a width of the engine.

In a case where the resistor and the component are located, for example, behind the engine, disposing the resistor and the component at or near the confluence point where the traveling wind from the front flows to the left and right of the engine and merges behind the engine facilitates effective air cooling of the resistor and the component by the outside air including the traveling wind.

(Configuration 9) The saddle-ride vehicle according to any one of configurations 1 to 8, in which the component is a canister that suppresses emission of evaporated fuel from the saddle-ride vehicle.

The canister, used as an environmental countermeasure component amid the growing emphasis on environmental issues, may cause fuel diffusion to the outside, albeit in minute amounts, due to temperature rise. In the present embodiment, even when the canister is disposed near the engine, the thermal effects of the engine on the canister can be reduced, thus suppressing the temperature rise of the canister and fuel diffusion from the canister itself to the outside. This can adequately prevent fuel diffusion from the saddle-ride vehicle to the outside, which contributes to environmental improvement and is suitable for the realization of the Sustainable Development Goals (SDGs).

### REFERENCE SIGNS LIST

10 Saddle-ride vehicle
11 Vehicle body frame
12 Power unit (engine)
13 Front wheel
15 Rear wheel (drive wheel)
23 Crankcase
24 Cylinder portion
29 Fuel tank
31 Vehicle body cover
32 Front cover
33 Middle cover
34 Lower side cover
35 Rear cover
41 Canister
41C Canister central axis
51 resistor
51F Heat dissipating fin
61 Drive motor
62 Driving circuit
W Traveling wind
LC Width center of saddle-ride vehicle

What is claimed is:

1. A saddle-ride vehicle comprising: an engine; and a component disposed near the engine,
wherein a member is disposed between the engine and the component, and
the member is a resistor that is one of the components of the saddle-ride vehicle.

2. The saddle-ride vehicle according to claim 1, wherein
the resistor is a component that is used only in a predetermined traveling condition.

3. The saddle-ride vehicle according to claim 1, wherein the resistor is a resistor for a drive motor provided in the saddle-ride vehicle.

4. The saddle-ride vehicle according to claim 3, wherein
the drive motor is a motor capable of driving a drive wheel of the saddle-ride vehicle, and
the resistor is used during backward traveling of the saddle-ride vehicle by the drive motor.

5. The saddle-ride vehicle according to claim 1, wherein the resistor includes a heat dissipating fin.

6. The saddle-ride vehicle according to claim 5, wherein the heat dissipating fin is provided on an engine side face of the resistor.

7. The saddle-ride vehicle according to claim 6, wherein the heat dissipating fin extends along a vertical direction of a vehicle body.

8. The saddle-ride vehicle according to claim 1, wherein the resistor and the component are disposed within a width of the engine.

9. The saddle-ride vehicle according to claim 1, wherein the component is a canister that suppresses emission of evaporated fuel from the saddle-ride vehicle.
